(19) United States
(12) Patent Application Publication
(10) Pub. No.: US 2014/0172813 A1
(43) Pub. Date: Jun. 19, 2014

(54) PROCESSING USER LOG SESSIONS IN A DISTRIBUTED SYSTEM

(71) Applicant: MICROSOFT CORPORATION, Redmond, WA (US)

(72) Inventors: Shengquan Yan, Issaquah, WA (US); Bai Xiao, Bellevue, WA (US); Yunqiao Zhang, Sammamish, WA (US); Peng Yu, Bellevue, WA (US); Yin He, Redmond, WA (US); Kevin Philip White, Seattle, WA (US); Brian Jude Frasca, Redmond, WA (US); Zijian Zheng, Bellevue, WA (US); Ravi Chandru Shahani, Bellevue, WA (US)

(73) Assignee: MICROSOFT CORPORATION, Redmond, WA (US)

(21) Appl. No.: 13/715,769

(22) Filed: Dec. 14, 2012

(51) Int. Cl. G06F 17/30

(52) U.S. Cl. CPC G06F 17/30864
USPC 707/706; 707/736

(57) ABSTRACT

Systems, methods, and computer media for efficiently processing user log data are provided. The log data is progressively processed in variable sized windows based on a specified time period. The log data may be anonymized to protect user privacy. A log server processes the windowed log data in phases. The first phase includes fast data like page view log data. Subsequent phases include slow data like session data which may build on the page view data processed in the first phase. The log server identifies metrics based on the log data processed at each phase. Based on the identified metrics, the log server may identify interests across a community of users or for specific users.

### BACKGROUND

Internet searching and browsing has become increasingly common. In an effort to provide targeted services and advertisements, search providers gather a variety of data related to user activity, including received user search queries. Such data is typically stored in user logs, which can easily contain terabytes of information for a single day and multiple petabytes of information overall. The extremely large size of user logs makes analyzing user log data a resource-intensive process.

Conventionally, analyzing user log data to identify data having particular desired features requires a computationally intensive scan of user logs in the entirety. Although distributed processing systems can improve performance of conventional user log analysis, the analysis still requires vast and expensive resources. The processing of the logs may take a very long time to complete as petabytes of information are logged daily.

Normally, logs are processed based on day boundaries by a conventional log engine. The log engine analyzes session behaviors (e.g., sessions per unique user per day.) However, current session definitions for most logs increase processing lag because there is a processing dependency across sessions. The current definition creates dependency between sessions that may be very long (e.g., a session that crosses multiple day boundaries.) Conventionally, sessions are defined based on inactive time periods within a day. For example, session identifiers are incrementally encoded as a natural number for each day and each time a specified period of inactivity occurs, a new session is opened with a new session identifier. Because the conventional log engine traditionally closes all sessions at the day boundary and begins new sessions after the day boundary, the log data may not be processed in an expedited manner due to dependencies that exist between sessions that span one or more days. Accordingly, log engines that utilize the conventional session definition face significant latency challenges when attempting to expeditiously process a very large amount log data.

### SUMMARY

Embodiments of the invention relate to systems, methods, and computer media for efficiently processing user log data. Logs having, among other things, user activity are processed to identify interests. The log data extracted from the logs are classified as fast data and slow data by a log server. In some embodiments, the fast data may be processed immediately. The slow data, on the other hand, must wait until the fast data is processed because the slow data is dependent on the fast data. Thus, the logs may be processed progressively by a log server to calculate metrics like page view metrics or session metrics. Accordingly, log data and metrics may be available sooner.

The log server, in one embodiment, calculates several of the page view metrics or session metrics by reconstructing user interaction from the log data and by determining the type of activity performed by the user. In turn, end-of-day metrics are identified based on the page view metrics and session metrics. For instance, the end-of-day metrics may be an aggregate of the page view or session metrics over a time period representing one day for one or more users.

The user interests may be identified based on any combination of the page view metrics, session metrics, and end-of-day metrics. The user interests may include companies, hobbies, and sports interests that correspond to the page views or sessions for the user. In certain embodiments, multiple log servers are employed to concurrently process the log data.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The embodiments of the invention are described in detail below with reference to the attached drawing figures, wherein:

FIG. 1 is a block diagram that illustrates an exemplary computing environment suitable for use in implementing embodiments of the invention;

FIG. 2 is a communication diagram that illustrates an exemplary search session stored in a log by a log server in accordance with embodiments of the invention;

FIG. 3 is a processing diagram that illustrates progressive processing performed by the log server in accordance with embodiments of the invention; and

FIG. 4 is a logic diagram that illustrates an exemplary method for processing a log in accordance with embodiments of the invention.

### DETAILED DESCRIPTION

The subject matter of this patent is described with specificity herein to meet statutory requirements. However, the description itself is not intended to necessarily limit the scope of the claims. Rather, the claimed subject matter might be embodied in other ways to include different steps or combinations of steps similar to the ones described in this document, in conjunction with other present or future technologies. Although the terms “step,” “block,” and/or “component,” etc., might be used herein to connote different components of methods or systems employed, the terms should not be interpreted as implying any particular order among or between various steps herein disclosed unless and except when the order of individual steps is explicitly described.

Embodiments of the invention relate to systems, methods, and computer media for progressively processing user logs in phases. A log server may operate in a first phase to process fast log data, like impression data.

As utilized herein, impression data comprise all the server and client events associated with a search engine results page (SERP), including search queries and the URLs included in the SERP; advertisement placeholders on a webpage accessed by user, webpages displayed to users; multimedia content accessed by the users; or client interactions with webpages, advertisements, or multimedia. As used herein, interactions refer to dependent activity associated with an impression. The interactions, include but are not limited to, clicks, hover, drag, drop, etc.

Subsequent phases process session data and end-of-day data. A log server may extract log data in phases based on user behavior. The log server may concurrently process log data identified as fast data before processing the slow data, which may depend on the fast data extracted in the first phase. Because the log server progressively processes the log, interests may be identified at each phase instead of waiting for an end-of-day trigger before identifying the interests. The interests include user hobbies, teams searched by the user, companies researched by the user, etc. In an embodiment of the invention, the log is a search log.

As discussed above, logs, including search logs, often contain terabytes of data for a single day and petabytes of data for an entire log, making user log data analysis a resource-intensive process. In one embodiment, a configurable session window allows the log server to identify user activity across day boundaries. In other words, user sessions that roll over day boundaries may be processed sooner because the phased processing does not require the log server to wait for a new end-of-day trigger before initiating processing of the user activity that crosses day boundaries. Additionally, the configurable session window reduces or completely avoids sequential session dependencies. This enables the log server to concurrently process sessions and to bi-directionally process the sessions. The log server is configured to perform bi-directional processing (i.e., both forward processing and backward processing in a stable manner based on the configurable session window.)

In certain embodiments, the log server processes the log data in at least three phases: page view, session, and end-of-day. The page view phase extracts impressions, which reflect what a user does on a specific page (e.g., search page.) The session phase extracts what a user does during one or more sessions, which may contain several page views. The end-of-day phase extracts what a user does during a specific day, which may contain multiple sessions. At each phase, the log server identifies metrics that may be used to identify interests. In at least one embodiment, the log data is anonymized to mask and protect user identity. In other embodiments, user authorization may be received before storing activity data and user identifying data in the logs.

Having briefly described an overview of embodiments of the invention and some of the features therein, an exemplary operating environment suitable for implementing the present invention is described below.

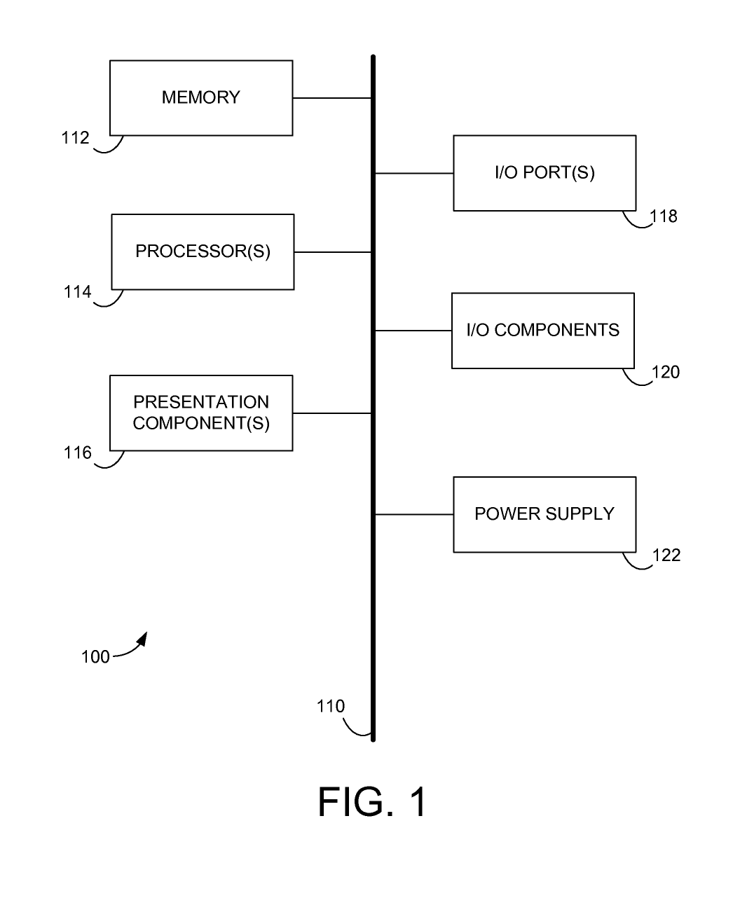

FIG. 1 schematically shows a system environment suitable for performing embodiments of the invention. Referring to the drawings in general, and initially to FIG. 1 in particular, an exemplary operating environment for implementing embodiments of the invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The embodiments of the invention may be described in the general context of computer code or machine-useable instructions, including computer-executable instructions such as program components being executed by a computer or other machine, such as a personal data assistant or other handheld device. Generally, program components including routines, programs, objects, components, data structures, and the like, refer to code that performs particular tasks or implements particular abstract data types. Embodiments of the invention may be practiced in a variety of system configurations, including handheld devices, tablet computers, consumer electronics, general-purpose computers, specialty computing devices, etc. Embodiments of the invention may also be practiced in distributed computing environments where tasks are performed by remote-processing devices that are linked through a communications network.

As one skilled in the art will appreciate, the computing device 100 may include hardware, firmware, software, or a combination of hardware and software. The hardware includes processors and memories configured to execute instructions stored in the memories. The logic associated with the instructions may be implemented, in whole or in part, directly in hardware logic. For example, and without limitation, illustrative types of hardware logic include field programmable gate array (FPGA), application specific integrated circuit (ASIC), system-on-a-chip (SOC), or complex programmable logic devices (CPLDs). The hardware logic allows the log server to extract page view data, session data, and end-of-day data. The log server progressively calculates the metrics as the log progressively extracts the log data based on whether the log data is classified as fast data or slow data. The log server identifies interests that may be used to, among other things, improve search performance or advertisement delivery. The computer device 100 may be a log server, which, in some embodiments, includes a distributed computer system for processing the fast data and the slow data.

With continued reference to FIG. 1, computing device 100 includes a bus 110 that directly or indirectly couples the following devices: memory 112, one or more processors 114, one or more presentation components 116, input/output (I/O) ports 118, I/O components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear and, metaphorically, the lines would more accurately be grey and fuzzy. For example, one may consider a presentation component, such as a display device, to be an I/O component. Also, processors have memory. The inventors hereof recognize that such is the nature of the art and reiterate that the diagram of FIG. 1 is merely illustrative of an exemplary computing device that can be used in connection with one or more embodiments of the invention. Distinction is not made between such categories as “workstation,” “server,” “laptop,” “handheld device,” etc., as all are contemplated within the scope of FIG. 1 and reference to “computer” or “computing device.”

Computing device 100 typically includes a variety of computer-readable media. Computer-readable media can be any available media that can be accessed by computing device 100 and includes both volatile and nonvolatile media, removable and non-removable media. Computer-readable media may comprise computer storage media and communication media.

Computer storage media includes volatile and nonvolatile, removable and non-removable media implemented in any method or technology for storage of information such as computer-readable instructions, data structures, program modules or other data. Computer storage media includes, but is not limited to, Random Access Memory (RAM), Read Only Memory (ROM), Electronically Erasable Programmable Read Only Memory (EEPROM), flash memory or other memory technology, CD-ROM, digital versatile disks (DVD) or other holographic memory, magnetic cassettes, magnetic tape, magnetic disk storage or other magnetic storage devices, or any other medium that can be used to encode desired data and that can be accessed by the computing device 100. In an embodiment, the computer storage media can be selected from tangible computer storage media like flash memory. These memory technologies can store data momentarily, temporarily, or permanently.

On the other hand, communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components 116 include a display device, speaker, printing component, vibrating component, etc. I/O ports 118 allow computing device 100 to be logically coupled to other devices including I/O components 120, some of which may be built in. Illustrative I/O components include a microphone, joystick, game pad, satellite dish, scanner, printer, wireless device, a controller, such as, a stylus, a keyboard and a mouse, or a natural user interface (NUI), etc.

The NUI processes air gestures, voice, or other physiological inputs generated by a user. These inputs may be interpreted as search requests, requests for interacting with search results on a search engine results page (SERP), or requests for interacting with a web page displayed by the computing device 100. These requests may be transmitted to the appropriate network element for further processing. The NUI implements any combination of speech recognition, touch and stylus recognition, facial recognition, biometric recognition, gesture recognition both on screen and adjacent to the screen, air gestures, head and eye tracking, and touch recognition associated with displays on the computing device 100. The computing device 100 may be equipped with depth cameras, such as, stereoscopic camera systems, infrared camera systems, RGB camera systems, and combinations of these for gesture detection and recognition. Additionally, the computing device 100 may be equipped with accelerometers or gyroscopes that enable detection of motion. The output of the accelerometers or gyroscopes is provided to the display of the computing device 100 to render immersive augmented reality or virtual reality.

Various aspects of the technology described herein are generally employed in computer systems, computer-implemented methods, and computer-readable storage media for, among other things, identifying interests from log data. The log server may extract data in a progressive manner and share state data corresponding to a configurable time period. For instance, the log server may be configured with three processing engines. A first processing engine for page view data. A second processing engine for session data. A third processing engine for end-of-day data. The log data, in some embodiments, is formatted to have unidirectional dependency such that slower data (e.g., end-of-day data) may depend on faster layers (e.g., page view data) but the fast data may not depend on the slow data. Thus, the first processing engine does not wait for the second processing engine or the third processing engine. Once the first processing engine is complete, the results of processing may be used as inputs to the second processing engine or third processing engine.

In yet another embodiment, the computer system includes a communication network having a search engine, client computers, and a log server. The log server is configured to store and process log data. A user may issue a search request on a client computer or request a web page or other multimedia content on the client computer. The search engine receives the search request or a web server may receive the request for the web page or multimedia content. The search engine returns a SERP and the web server returns the requested web page or multimedia content. In some embodiments, the search engine generates the search logs and sends the search logs to the log server for processing. In other embodiments, the log server may store the search request or the location requested for the web page or multimedia content, e.g. uniform resource locator (URL). In turn, the user may issue interaction commands via the client computer. These interaction commands may also be stored in the log server along with an identifier for the user.

The interactions, in some embodiments, are identified as impressions and may be stored as one or several sessions based on the level of inactivity between interactions. For instance, if thirty minutes elapses between a first interaction and a second interaction, the first interaction may be stored as a first session and the second interaction may be stored as a second session. Once the impression data is logged and an appropriate length of time has passed, the log server may begin the first phase processing to identify interests.

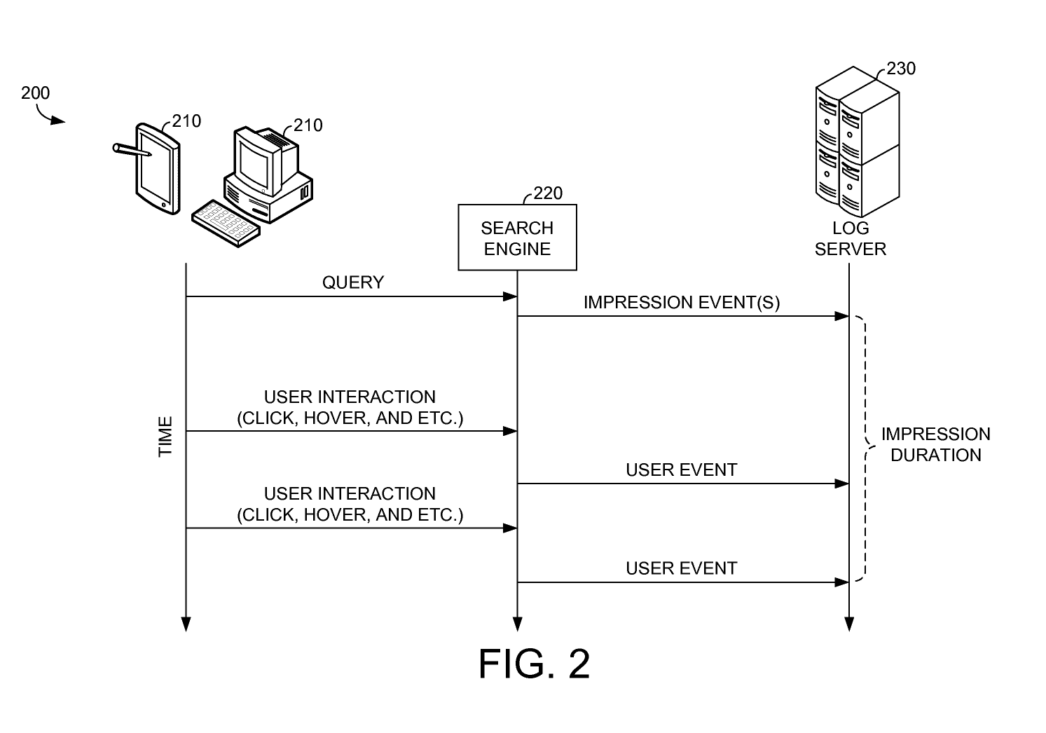

FIG. 2 is a communication diagram 200 that illustrates an exemplary search session stored in a log by a log server 230 in accordance with embodiments of the invention. A communication network may connect client computer 210, search engine 220, and log server 230.

The client computer 210 may issue a query in response to a user search request. The client computer 210 may receive a SERP from the search engine 220 in response to the search request. The user may interact with the SERP by clicking, hovering, dwelling, etc. These interactions may be transmitted from the client computer 210 to the search engine 220.

In certain embodiments, the search engine 220 may store the query and user interactions in a log maintained by the log server 230. The query may be stored as an impression and the interactions may be stored as user events. The log server may format the impression and interactions received from the search engine and may include an identifier for the user or the client computer 210. The identifier may be an anonymized identifier for the user or the client computer.

In some embodiments, an impression in the log maintained by the log server 230 contains all the server and client events associated with a SERP. For instance, the impression data may include the search query and the URLs included in the SERP. User events include user interactions (like click or hover) on the SERP. The logs may also include timestamps associated with the impressions and interactions.

In one embodiment, the logs may be stored temporarily in a memory buffer, flash drive, or hard disk. When the impression and interaction data is received from the search engine 220, the log server generates the corresponding logs and stores them. Once an appropriate time window (e.g. 2-3 hours) has elapsed, the logs will be processed as fast data. During the first phase of processing, the log server 230 processes the impressions and user interactions included in the log to calculate page view metrics. For each impression or interaction, the log server 230 may have two timestamps that are recorded in the log. The first timestamp is a start timestamp and the second time stamp is an end timestamp. Based on these timestamps, the log server 230 may calculate, among other things, an impression duration, which may be defined as:

Max(end_Timestamp)−Min(start Timestamp).

After processing the page view data (impressions and interactions), the log server 230 may begin a second phase of processing that extracts session data. In certain embodiments, a session in the log is represented as a sequence of consecutive impressions having the same identifier where the time period between any two consecutive impressions is shorter than 30 minutes. In other words, a session may be an array of impressions. Based on this session definition, the log server 230 may calculate, among other things, a session duration, which may be defined as:

Max(end_Timestamp_of_last_impression)−Min(start_Timestamp_of_first_impression).

After processing the page view data (impressions and interactions) and session data, the log server 230 may begin a third phase of processing that extracts end-of-day data. In certain embodiments, the end-of-day data is represented as a sequence of consecutive sessions having the same identifier where the time period expires at the end-of the day. In other words, the end-of-day data may be an array of sessions. Based on this session definition, the log server 230 may calculate, among other things, an end-of-day duration, which may be defined as:

Max(end_Timestamp_of_last_session)−Min(start_Timestamp_of_first_session)

Using these calculations, the log server 230 may identify interest for the user. For instance, the log entries having the longest impression duration, session duration, or end-of-day duration may be selected as interests for the user. These interests may, in some embodiments, be used to target advertisements to the user or to improve the display and ranking to search results. The search result URL relevance rankings, for instance, may be modified to consider the interests identified by the log server 230.

Accordingly, as explained above the log server processes the fast data before slow data. The log server is configured to identify interests based on metrics calculated from the fast data or slow data. The metrics may include any of the following: page view (impression) metrics, session metrics, and end-of-day metrics.

In additional embodiments, the log server may specify a variable window for processing impressions and sessions. The window represents a time period during which log data is extracted. In some embodiments, the configurable time period may vary based on the type of log data being processed by the log processor. In certain embodiments, the page view data may be processed in two-hour or three-hour windows, session data may be processed in four-hour windows, and end-of-day data may be processed in 24-hour windows. The windowing of the log data enables the log server to process page view data, session data, and end-of-day data concurrently.

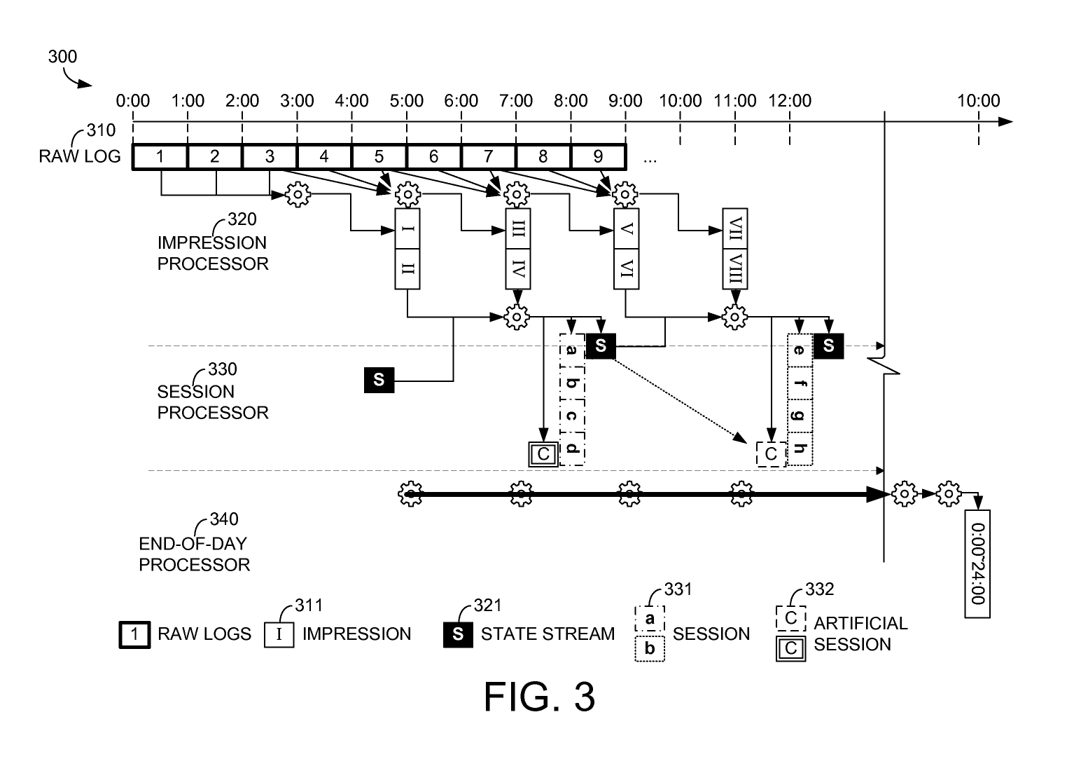

FIG. 3 is a processing diagram 300 that illustrates progressive processing performed by the log server in accordance with embodiments of the invention. The log server obtains raw log data from its storage and processes the raw log by at least three distributed processors executed or managed by the log server, in an embodiment of the invention. The first processor may be the impression processor 320. The second processor may be the session processor 330. The third processor may be the end-of-day processor 340. The processors 320, 330, and 340 are illustrated in top-to-bottom fashion for ease of discussion. One of ordinary skill in the art appreciates and understands that this top-to-bottom illustration does no limit the manner in which the processors are physically connected. In some embodiments, the raw log data is stored in hourly segments by the log server.

When the impression processor 320 is initialized it groups the hourly log data based on the configurable window size (e.g., three hours) for impression processing. For instance, the raw log data may be grouped into three-hour segments to process a two-hour segment of log data. The extra hour of padding is added to help the log server maintain dependency among impressions and interactions within the two-hour segment that is being processed by the impression processor 320. The padding also allows the impression processor to tolerate a page view's duration and latency problems with networks, hard drives, processors, etc.

For instance, a click user interaction may not happen until 10 minutes later after the page view starts as requested by the impression 311 due to internal network latency and data upload delay. These delays may further exacerbate differences between timestamps ultimately assigned to the user interaction. The three-hour segments obtained by the impression processor 320 may be processed independently to improve throughput and may allow the impression processor 320 to reprocess a prior three-hour segment of log data in an efficient manner without stalling a current three-hour segment of log data. The three-hour segment of log data is processed to calculate page view metrics (click frequency, duration, etc.). In turn, the page view metrics may be used by the log server to identify interests from the raw log data 310.

Once an appropriate number of impressions 311 is processed by impression processor 320, the session processor 330 obtains a four-hour segment from the log data. The four-hour segments of log data may be constructed from previous three-hour segments processed by the impression processor 320. The session metrics, like session duration, average dwell time, and total dwell time, are computed by the session processor 330. In certain embodiments, the session processor 330 does not initiate until at least six-to-eight hours of impression processing is complete.

Finally, when both impression and session data processing are complete, end-of-day processing, in some embodiments, is triggered for a daily window (e.g., 22 hours to 24 hours) on the end-of-day processor 340.

The raw log 310 contains the impression data and interaction data. In some embodiments, the interaction data may have a dependency on the impression data. The raw log includes, among other things, timestamps that are used to identify the user of the client computer and the corresponding impressions or interactions. The raw log attempts to maintain the dependency between the impression data and the interaction data. However, depending on the size of the window, disk latency due to reads and writes, it may be difficult to enforce this dependency.

In certain embodiments, the impression processor 320 reads raw logs in a given window tₛ, with a delay time of w₁. For instance, the delay time may be one hour and the given window tₛ may be two hours. The effective window for the impression processor 320 would be tₛ+w₁. The read delay w₁ may tolerate impression and upload delay to achieve the desired accuracy. However, in some embodiments, dependent page views (interactions) that arrive later than tₛ+w₁ may be classified as lost traffic.

In one embodiment, the impression processor 320 is configured to process log data, specifically impressions that started in the given window tₛ. The impression window tₛ allows the impression segment to include impressions and corresponding user activity that are within tₛ or that are not directly within tₛ. In other words, if an interaction is dependent on an impression within tₛ but the interaction has a timestamp outside of the tₛ, the impression processor 320 may include the related impression within a given tolerance of time. In some embodiments, the timestamp for the interaction tₙ may have a proxy timestamp based on the timestamp of the impression tₘ (e.g., the start time for impression.)

But for interactions outside of the effective window tₛ+w₁, the impression processor 320 includes the interaction in the impression segment 311 when the impression processor 320 is able to find an impression 311 from which the interaction depends and the impression timestamp tₘ is within the effective window tₛ+w₁. The impression processor 320 substitutes the timestamp for the interaction tₙ with the timestamp of the impression tₘ (e.g., the start time for impression.) If tₘ is greater than the effective window tₛ+w₁, the impression and interaction will not be included in the current impression segment 311. The impression processor 320 extracts the impression 311 to determine the page view metrics.

The session processor 330 manages session segments 331. As explained above, sessions are partitioned by 30 minutes of inactivity. The session segments 331 may include several impressions processed by the impression processor 320. A session identifier is partly based on the session's start timestamp. In one embodiment, the session identifier is “Date”+“ID,” where the “ID” represents the timestamp of the first impression of a session. For example, a session started at 01:59 on 2012-03-14 can be “201203140159” or an integer of (current day−2000)*10000+timestamp's total seconds in the day. This session ID may move into the next day because using a timestamp as the ID avoids session dependency while preserving the session order. If a session extends for more than four hours, the session processor 330 artificially creates a session boundary at each 4-hour period. The artificial sessions limit the tendency period, which allows the log server to process the log data sooner.

The session segments 331 are limited in duration. In an embodiment, a session may not exceed four hours. If a new session segment 331 is created by the session processor 330 due to a previous session hitting the four-hour cut-off, then the new session is classified as an artificial session 332 by the session processor 330. Otherwise, the session processor 330 starts a new session segment after 30 minutes inactivity lapses from the last activity received for a current session. The new session would be classified as a natural session because it was not abruptly shut down to enforce the four-hour cut-off.

The session processor 330 may allow session segments 331 to cross over the day boundary. In some embodiments, only natural sessions are allowed to cross day boundaries. If the session is not a natural session, the session processor 330 closes the session before the beginning of the new day and creates a new session segment 331 for the subsequent activity received on the new day. Session dependency is contained within at least two consecutive sessions. For instance, a natural session depends only on its previous session. Because natural sessions cross day boundaries, day to day dependency may be constrained to at most four hours.

A session segment 331 is sealed if the session processor 330 can find the start and end session boundary. A session is unsealed if the session processor 330 is yet to detect the close boundary. Because a session can easily span hours, a forward processing technique may be costly due to delays in processing. In some embodiments, a state stream stores state data having dependency information from a prior session processing window. The next session may use the state data to construct the session metrics. The state stream 321 may identify artificial sessions 332. In one embodiment, the state stream 321 contains a user or client identifier and the identifier for the next session. The impressions 311 are joined based on the state stream so that session processor 330 can assign session IDs in sequence. The session processor 330 calculates the session metrics from the session segments 331.

In some embodiments, a debug stream may be used to monitor processing of the log data and to recover error states at the end-of-day. The log server may locate and reconstruct lost traffic based on the debug stream. For instance, when log data having a timestamp that is outside of the processing window, the log server may ignore the log data. The debug stream may include, among other things, a number of lost impressions and a number of lost interactions.

The end-of-day processor 340 increases the window size to 24 hours and obtains the session segments that are within the given time period. The end-of-day processor, in certain embodiments, aggregates the impression metrics and session metrics. Also, the end-of-day processor 340 is configured to recover lost or orphaned traffic without reprocessing the entire log.

If the end-of-day processor 340 detects a significant amount (5-10%) of lost traffic at the end-of-day aggregation of the session metrics, or if the end-of-day processor 340 reprocesses a log due to late arrivals after a daily view is constructed, the end-of-day processor 340 performs the following steps. If the log server receives logs that are late arrivals, the log server can reprocess (e.g., backward process) the last rolling window instead of the entire log. If a user or client has lost traffic, the log server may reprocess the log data for the user or client based on the available identifier and the lost traffic data, which may be accessible via the debug stream.

The progressive phasing allows normal processing mode (forward mode) of logs that arrive day by day. The log server generates a state stream to carry over unfinished cross-day sessions when it processes the current day. The unfinished sessions may be completed in the next day's sessions. The forward mode doesn't work well for the reprocessing scenario; however, the log server may reprocess the unfinished sessions concurrently and in backward order.

The end-of-day processor 340 switches to a backward processing mode to process lost traffic or late arriving log data. In this mode, the end-of-day processor 340 extracts a four-hour segment of session data to rebuild the page view or session metrics for a processing day. In some embodiments, the processing day is the day before the time period associated with the lost traffic or the later arriving log data. The end-of-day processor 340 utilizes the debug streams to concurrently process the day associated with the lost traffic or the later arriving log data. The log server may assign a priority for processing log data for page views, sessions, or end-of-day metrics. The reprocessing steps may include the following:

Assume that log server has missing data or new data for day N, the log server may process the impression segments for day N−1. If the lost traffic or additional data is for day N, the log server obtains the last two or three impression (6:00 p.m, to 12:00 a.m.) windows for day N−1 and builds a state stream based on this data. In turn, the rebuilt state stream and log data are processed by the log server. The page view, session, and end-of-day processes are executed on the missing traffic based on the debug stream data by the log server.

Accordingly, a log server progressively processes the log data. The log server calculates metrics based on page view data (impressions), session data, and end-of-day data. The log server is also able to track lost traffic and reprocess segments of the log to correct the metrics after reprocessing is complete. These metrics are used to track user interests for selecting search results or advertisements that could be delivered to a user.

In certain embodiments, the log server identifies interests from log data. The log data may include search queries, search results, and user interaction data. The log server may select the interests from the stored log data based on the metrics calculated from progressively processing the log data.

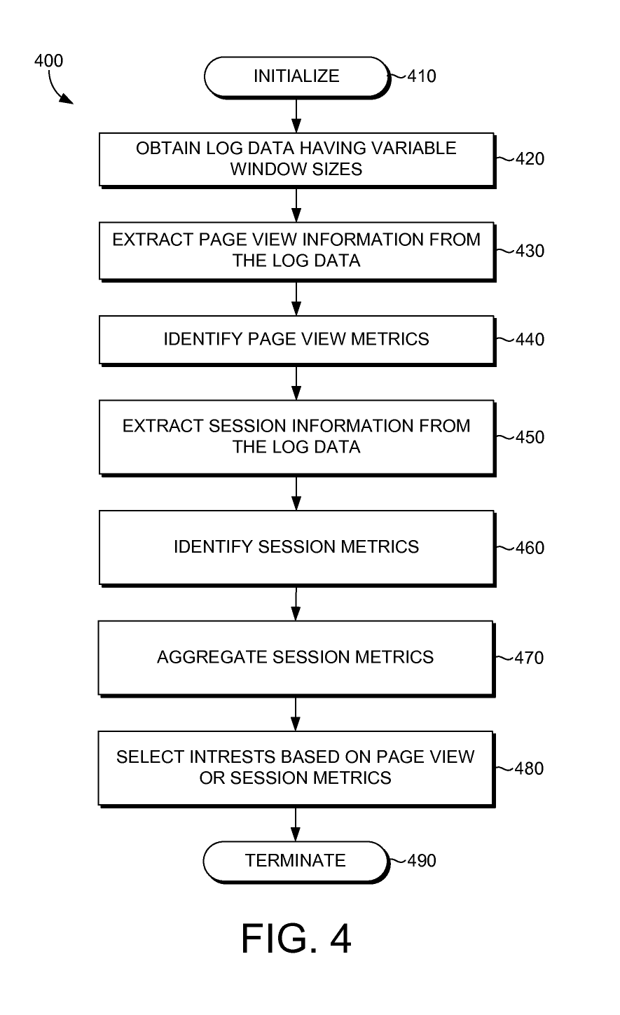

FIG. 4 is a logic diagram that illustrates an exemplary method for processing a log in accordance with embodiments of the invention. The method initializes in step 410. In step 420, the log server obtains log data having variable window sizes. The window size is a time period associated with the log data. The variable window size is updated based on the phase of processing. For instance, for page view data the window size may be two or three hours, for session data the window size may be four hours, and for end-of-day data, the window size may be between 22 and 24 hours. In some embodiments, the window size ranges from one to four hours.

In turn, the log server extracts page view data from the log data, in step 430. The page view data may include links to content hovered over by the users or links to content clicked on by the users. The content may comprise multimedia data, websites, or search results. Page view metrics are identified by the log server based on the extracted page view data, in step 440. The page view metrics, in one embodiment, include any of the following: number of clicks, number of visits, and length of visit.

The log server extracts session data from the log data, in step 450. The extracted page view data may be a portion of the session data. The session data, in some embodiments, may be reconstructed from the extracted page view data contained in the log data. The extracted page view data may be batched for processing based on a specific period of time. A session may be closed artificially by the log server when the specific period of time expires. The specific period of time may be four hours, in an embodiment of the invention. In step 460, the log server identifies session metrics based on the extracted session data.

The log server may process the session data in four-hour windows to obtain the session metrics, which include any of the following: a start time for a session, an end time of the session; an indication of whether the session was closed artificially, and a length of the session. The session metrics may also include the number of queries issued in a search session. The log server may calculate the number of queries by adding the number of queries identified in each of the impressions included in the log.

The session metrics constrained to a calendar day are aggregated by the log server, in step 470. The log server may process at least six batches of session data to reconstruct a 24-hour time period. The log server may reconstruct daily search, viewing, or clicking patterns from the aggregated session data. The daily viewing patterns include aggregated page view metrics or aggregated session metrics. In turn, the log server selects interests of one or more users based on one or more of the following: daily viewing patterns, session metrics, and page view metrics, in step 480. The metrics calculated by the log server may include the number of sessions issued per user per day. The users may be identified in an anonymous manner by the log server. The method terminates in step 490.

In summary, a log server performs a variety of datamining and analysis tasks on a log. The log itself contains different user behavior data. Some of the user interactions may be available with short latency but others may not be available until many hours later. The log server progressively processes the log data to reduce latency associated with providing metrics for page views, sessions, and end of day. The progressive processing by the log server also reduces overall processing costs by distributing processes. This reduces failure costs as compared to processing the log data as a single large job.

The metrics produced via data analysis by the log server show how changes in page layout impact user interaction with the pages, effectiveness of advertisement placement, etc. The interests identified based on the metrics may be surfaced to the user as topics or suggested queries.

The described embodiments are intended in all respects to be illustrative rather than restrictive. Alternative embodiments will become apparent to those of ordinary skill in the art to which the present invention pertains without departing from its scope. From the foregoing, it will be seen that this invention is one well adapted to attain all the ends and objects set forth above, together with other advantages which are obvious and inherent to the system and method. It will be understood that certain features and sub-combinations are of utility and may be employed without reference to other features and sub-combinations. This is contemplated by and is within the scope of the claims.

The technology claimed is:

1. A computer-implemented method for processing a log, the method comprising:
obtaining log data having variable window sizes;
extracting page view data from the log data;
identifying page view metrics based on the extracted page view data;
extracting session data from the log data, wherein the extracted page view data may be a portion of the session data; and
identifying session metrics based on the extracted session data.

2. The computer-implemented method of claim 1, further comprising:
aggregating session metrics constrained to a calendar day;
reconstructing daily viewing patterns from the aggregated session data; and
selecting interests based on one or more of the following: daily viewing patterns, session metrics, and page view metrics.

3. The computer-implemented method of claim 1, wherein the window size is a time period associated with the log data and ranges from one to four hours.

4. The computer-implemented method of claim 2, wherein the daily viewing patterns include aggregated page view metrics or aggregated session metrics.

5. The computer-implemented method of claim 1, wherein users are identified in an anonymous manner.

6. The computer-implemented method of claim 5, wherein the page view data includes links to content hovered over.

7. The computer-implemented method of claim 5, wherein the page view data includes links to content clicked on.

8. The computer-implemented method of claim 7, wherein the content includes multimedia data, websites, or search results.

9. The computer-implemented method of claim 1, wherein page view metrics include any of the following: number of clicks, number of visits, and average length of visit.

10. The computer-implemented method of claim 1, wherein the session data is reconstructed from the extracted page view data contained in the log data.

11. The computer-implemented method of claim 10, wherein a state stream stores data from a prior session window for the current session.

12. The computer-implemented method of claim 11, wherein a session is closed artificially when the specific period of time expires.

13. The computer-implemented method of claim 12, wherein the specific period of time is four hours.

14. The computer-implemented method of claim 13, wherein session metrics include any of the following: a start time for a session, an end time of the session; an indication of whether the session was closed artificially, and a length of the session.

15. The computer-implemented method of claim 14, wherein the session data is processed in four-hour windows.

16. The computer-implemented method of claim 15, wherein at least six batches of session data are processed to reconstruct a 24-hour time period.

17. One or more computer servers configured to process log data and identify interests, the servers providing one or more of the following:
a search engine to receive search requests and to provide search results to users;
a log to store user interactions with the search engine and content included in the search results; and
a log server to process the logs in phases that extract fast data and slow data associated with the user interactions, wherein interests are determined at each phase and the interests are identified without processing the entire log.

18. The computer-implemented method of claim 17, wherein the search engine provides a search engine results page; and the log stores an identifier of a user or computer, URLS or other page identifying data, time stamps, click, hover, view, or visit content interactions associated with the search engine results page.

19. The computer-implemented method of claim 17, wherein fast data includes page views and slow data includes session data and day data, slow data has a dependency on fast data, and the page views, session data, and day data are processed in variable-sized windows constrained by fast data having a smaller window size than slow data.

20. One or more computer-readable media storing computer-usable instructions for performing a method to process log data and identify interests, the method comprising:
extracting page view data from the log data;
identifying page view metrics based on the extracted page view data;
extracting session data from the log data, wherein the extracted page view data may be a portion of the session data;
identifying session metrics based on the extracted session data;
aggregating session metrics constrained to a calendar day;
reconstructing daily viewing patterns from the aggregated session data; and
selecting interests based on one or more of the following: daily viewing patterns, session metrics, and page view metrics.
